(19) United States
(12) Patent Application Publication
(10) Pub. No.: US 2005/0260904 A1
(43) Pub. Date: Nov. 24, 2005

(54) Laminate having high moisture vapor transmission rate

(76) Inventors: Chris Shepherd, Issaquah, WA (US); John Cahill, Hudson, OH (US); Earl Shepherd, Sammamish, WA (US)

Correspondence Address: FLYNN THIEL BOUTELL & TANIS, P.C., 2026 RAMBLING ROAD, KALAMAZOO, MI, 49008-1631, US

(21) Appl. No.: 10/850,898

(22) Filed: May 21, 2004

(51) Int. Cl. B32B 27/12; B32B 27/04; B32B 27/02; B32B 5/02; B32B 29/02; B32B 17/12; B32B 5/22; B32B 5/26; B32B 17/02; B32B 17/06; B32B 5/24; B32B 5/18

(52) U.S. Cl. 442/43; 442/35; 442/20; 442/22; 442/26; 442/33; 442/46; 442/49; 442/76; 442/86

(57) ABSTRACT

A laminate having a moisture vapor transmission rate greater than one perm is formed from an open mesh fabric having a monolithic liquid barrier and vapor permeable coating provided on a surface thereof. The infiltration of air and bulk moisture to the interior of a building structure can be prevented by incorporating the laminate into the building structure. The laminate can also be used as a window flashing and vehicle undersiding to prevent the infiltration of air and bulk moisture.

### FIELD OF THE INVENTION

The present invention relates generally to a laminate which is used in preventing the infiltration of air and bulk moisture into the interior of a building, including walls, roofs and as window flashing, and as a component in vehicle envelope protection from moisture and corrosive agents.

### BACKGROUND OF THE INVENTION

Protective wraps are used throughout the construction industry to prevent against air infiltration and damaging moisture build-up in residential and commercial construction. As materials used for preventing the infiltration of air and bulk moisture to the interior of a building, polymer-coated papers and water-resistant sheathing materials are well known, with breathable materials which prevent the infiltration of air and bulk moisture into the interior of a building while allowing the outward passage therethrough of moisture vapor being particularly popular.

Breathable materials are usually formed from a flexible or rigid substrate having a polymer layer provided thereon which has been mechanically or electrically perforated, embossed, stretched or otherwise mechanically worked to form passages therein which are small enough to prevent the flow of air and water therethrough but large enough to allow the passage of water vapor and are provided in the form of woven, perforated and microporous building wraps. However, these types of conventional breathable materials have problems in the formation of passages which have to strike a balance between being small enough to prevent the flow therethrough of air and bulk moisture but large enough to allow the passage of moisture vapor therethrough. In certain situations, these conventional breathable materials can allow the passage of bulk moisture from an outside surface to the interior surface thereof, particularly if the bulk moisture is contaminated with a surfactant.

Roofing systems typically contain underlayment to aid in the drainage of moisture off the roof and help block the permeation of bulk moisture into the interior of the roofing system. Although some “breathable” underlayments are currently being used, the manufacture of them are so expensive as to be cost-prohibitive in some applications.

Recreational vehicles typically have undersiding applied thereto to protect the underside of the recreational vehicle from bulk moisture intrusion and corrosive agents and allow moisture vapor to escape. The current materials being used as vehicle undersiding include non-perforated woven polymers, galvanized steel, molded plastic sheets and woven polymer laminates. However, none of these materials both effectively prevent bulk moisture intrusion and allow moisture vapor to escape.

Flexible flashing is adhered around window flanges and jambs as strips of material between 4 and 24 inches wide to prevent bulk moisture intrusion and allow moisture vapor to escape. Flexible window flashing such as asphalt-saturated organic Kraft paper, polymer-coated reinforced organic Kraft paper and SBS-modified asphalt having polymer-based films provided on a surface thereof are typically adhered around window flanges and jambs using conventional sealants. These conventional flexible flashing have problems with respect to their inability to allow moisture vapor to escape from the wall cavity around windows and doors and effectively withstand bulk moisture penetration.

U.S. Pat. Nos. 6,133,168 and 6,541,072 to Doyle et al disclose coated substrates having a moisture vapor transmission rate greater than about five perms which are formed from a substrate, a monolithic, extrusion coated breathable polymer layer and a primer layer provided between the substrate and used in the construction industry for preventing the infiltration of air and bulk moisture while allowing the outward passage of moisture vapor. However, these coated substrates tend to be fairly expensive due to the complicated process needed for the formation thereof and can lack sufficient tear and tensile strengths.

U.S. Pat. No. 6,550,212 to Lubker, XII discloses a protective drainage wrap made up of a first portion comprising cross-woven or cross-laminated materials in the machine direction and in the transverse direction, with the material in the transverse direction having a thickness at least two times greater than the material in the machine direction, and a second portion comprising a coating or a solid sheet portion provided on the first portion. The first portion aids in the drainage of moisture build-up while open interstices/spaces in the first portion allow for natural vapor transmission. As the solid sheet portion, a breathable film is disclosed. The protective drainage wraps of U.S. Pat. No. 6,550,212 have a problem in that although they allow the transmission of moisture vapor to the outside of the wraps, there is also the possibility of bulk moisture transmission from the outside to the inside of the wraps.

### SUMMARY OF THE INVENTION

A first embodiment of the present invention is directed to a laminate having a moisture vapor transmission rate greater than one perm and comprising an open mesh fabric having a monolithic liquid barrier and vapor permeable coating provided on a surface thereof.

In a second embodiment of the present invention, a substrate of a non-woven thermoplastic fabric, foam layer, organic Kraft paper or organic felt paper is provided on an opposite surface of the open mesh fabric of the first embodiment.

In a third embodiment of the present invention, the monolithic liquid barrier and vapor permeable coating is provided between and adhered to the open mesh fabric and the substrate of a non-woven thermoplastic fabric, polymeric foam layer, organic Kraft paper or organic felt paper.

Another embodiment of the present invention is directed to a roofing system containing a laminate according to either the first, second or third embodiments of the present invention.

A fifth embodiment of the present invention is directed to a recreational vehicle undersiding comprising a laminate according to either the first, second or third embodiments of the present invention.

A sixth embodiment of the present invention is directed to a window flashing comprising a laminate according to either the first, second or third embodiments of the present invention.

Another embodiment of the present invention is directed to a method of preventing the infiltration of air and water to the interior of a building structure which comprises the steps of incorporating into the building structure a laminate according to the first, second or third embodiments of the present invention.

An eighth embodiment of the present invention is directed to a building structure which comprises a laminate according to the first or second embodiment attached to at least one framing member.

The laminates of the present invention are lightweight, have a high strength and are capable of providing an effective moisture vapor transmission rate therethrough while being an effective liquid and moisture barrier.

### BRIEF DESCRIPTION OF THE DRAWINGS

FIG. 1 is a perspective view showing a laminate according to a first embodiment of the invention;

FIG. 2 is a cross-sectional view of the embodiment of FIG. 1 showing the arrangement of the open mesh thermoplastic fabric and the monolithic liquid barrier and vapor permeable coating;

FIG. 3 is a perspective view of a second embodiment of the present invention;

FIG. 4 is a sectional view along the section line 4-4 of FIG. 3 illustrating the arrangement of the open mesh thermoplastic fabric, monolithic liquid barrier and vapor permeable coating and a substrate of a non-woven thermoplastic fabric, polymeric foam layer, organic Kraft paper or organic felt paper;

FIG. 5 is a perspective view of a third embodiment of the present invention;

FIG. 6 is a sectional view along the section line 6-6 of FIG. 5 illustrating the arrangement of the open mesh thermoplastic fabric, monolithic liquid barrier and vapor permeable coating and substrate;

FIG. 7 is a perspective view of a third embodiment of the present invention wherein the monolithic liquid barrier and vapor permeable coating is provided on both sides of the open mesh thermoplastic fabric;

FIG. 8 is a sectional view along the section line 8-8 of FIG. 7 illustrating the arrangements of the monolithic liquid barrier and vapor permeable coatings, open mesh thermoplastic fabric and substrate; and

FIG. 9 illustrates a laminate according to the second embodiment of the present invention attached to framing members.

### DETAILED DESCRIPTION

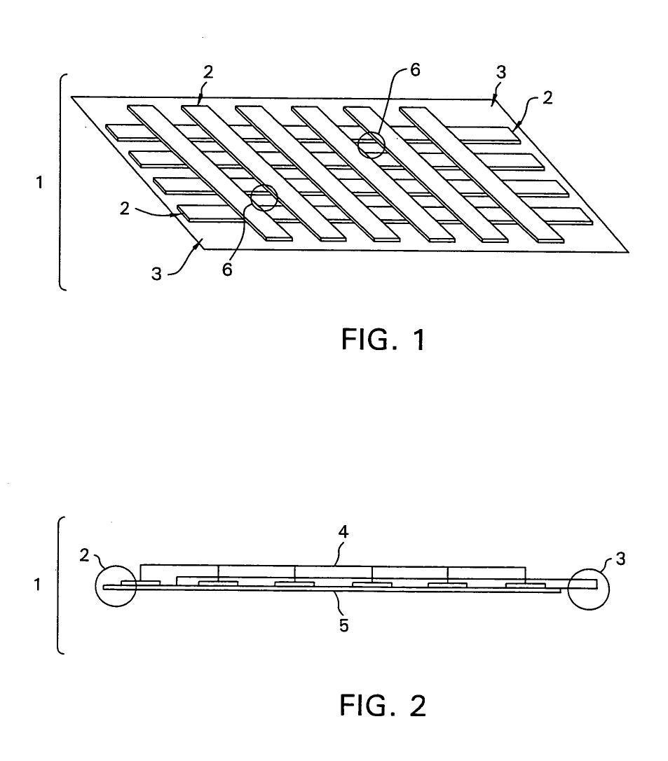

As illustrated in FIGS. 1 and 2, a laminate 1 according to a first embodiment of the present invention is made up of an open mesh fabric 2 having a monolithic liquid barrier and vapor permeable coating or film 3 provided on a surface thereof.

Although an open mesh thermoplastic fabric 2 is shown in the figures and is thermally bonded, the present invention is not limited thereto and woven, non-woven, knitted and molded thermoplastic, glass, graphite, acrylic and polycarbonate fabrics having an “open mesh” configuration where spaces 6 are formed between the fabric's strands or fibers 4,5 are interchangeable in the present invention for the open mesh thermally bonded thermoplastic fabric. The woven and non-woven thermoplastic fabric is preferably made of a polyolefin, a polyester, a polyamide or mixtures or blends thereof and has a weight of at least five grams per square meter. The open mesh thermally bonded thermoplastic fabric 2 is formed from vertical strands of a thermoplastic fabric 4 and horizontal strands of a thermoplastic fabric 5 thermally bonded to each other and has a weight of at least five grams per square meter. The open mesh thermally bonded thermoplastic fabric 2 is preferably made of a polyolefin, a polyester, a polyamide or mixtures or blends thereof. Spaces 6 are formed in the open mesh thermally bonded thermoplastic fabric 2 between the vertical strands 4 and the horizontal strands 5.

Alternatively, the strands of the open mesh thermally bonded thermoplastic fabric 2 can run in the diagonal direction with respect to each or any other manner as long as crossing strands are thermally bonded to each other and spaces 6 are provided in the fabric 2. Additionally, the configuration of the strands 4,5 is not critical as the thickness and width of either strand can vary in any direction and the strands 4,5 can have flat, square, triangular, circular, etc., cross-sectional areas.

The monolithic liquid barrier and vapor permeable coating 3 is substantially impermeable to bulk moisture but has a molecular structure which enables moisture vapor to pass therethrough. The monolithic liquid barrier and vapor permeable coating 3 is formed from conventionally known permeable resins such as copolyesters, polyesters, polyurethanes, acrylic polymers, polyethers, ester-ether copolymers as well as blends and copolymers thereof. The combined thickness of the monolithic liquid barrier and vapor permeable coating 3 is not critical and can be approximately 1 mil or thicker and preferably is approximately 1 mil. A particularly preferred breathable polymer is a copolyester.

The monolithic liquid barrier and vapor permeable coating 3 can be applied to the open mesh fabric by any suitable means such as laminating as a film onto the fabric 2 or extrusion coating the monolithic liquid barrier and vapor permeable coating 3 directly onto the open mesh thermoplastic fabric 2.

In order to enhance bonding between the open mesh fabric 2 and the monolithic liquid barrier and vapor permeable coating 3, the fabric 2 can be subjected to corona discharge treatment according to well-known procedures. It is believed that the corona discharge treatment chemically roughens the surface of the fabric 2 to enable a stronger bond to be formed between the fabric and the coating 3.

An alternative method of laminating the open mesh thermoplastic fabric 2 to the substrate (non-woven, felt, Kraft or foam) is to co-extrude two layers of the breathable resin, one on the surface of the open mesh fabric and one on the adjacent side. Co-extrusion methods for coating the open mesh fabric 2 and laminating the open mesh fabric 2 to the substrate are well known in the art. With the present invention, there is no need for an intermediate “primer layer” as satisfactory adhesion is provided between the open mesh thermoplastic fabric 2 and the monolithic liquid barrier and vapor permeable coating 3. Lamination techniques for adhering thermoplastic materials together are well known and can be used in the present invention as are processes for the extrusion coating of a layer of a polymer onto a supporting substrate and laminating the plies together.

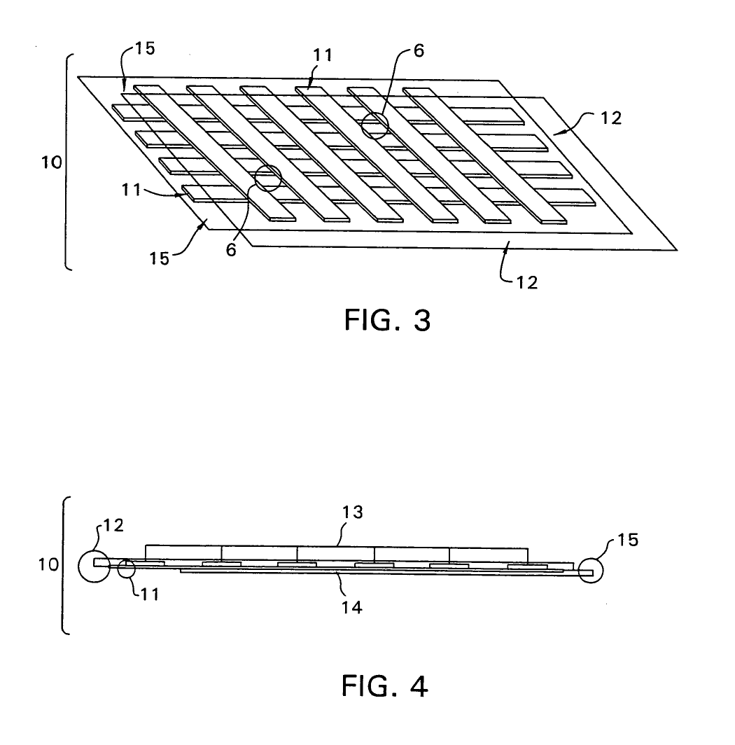

A second embodiment of the present invention is illustrated in FIGS. 3 and 4. The laminate 10 of the second embodiment of the present invention is formed from an open mesh fabric 11, a monolithic liquid barrier and vapor permeable coating or film 12 and a substrate of a non-woven thermoplastic fabric, polymeric foam layer, organic Kraft paper or organic felt paper 15 having a weight of at least one ounce per square yard. The open mesh 11 of the second embodiment of the present invention is similar to the open mesh fabric 2 of the first embodiment of the present invention and also is formed from vertical strands of fabric 13 and horizontal strands of fabric 14 having spaces 6 provided therebetween. The monolithic liquid barrier and vapor permeable coating or film 12 in the second embodiment of the present invention is identical to the monolithic liquid barrier and vapor permeable coating or film 3 of the first embodiment of the present invention and is provided on one surface of the open mesh fabric 11 with the substrate of a non-woven thermoplastic fabric, polymeric foam layer, organic Kraft paper or organic felt paper 15 being provided on an opposite surface thereof. The non-woven thermoplastic fabric 15 is preferably formed from a thermoplastic material such as a polyolefin, a polyester, a polyamide and mixtures thereof.

The non-woven thermoplastic fabric 15 can be spun-bonded, stitch bonded, needle punch, slit film or melt-blown thermoplastic material and can be used individually, in laminates of each other or as components in a laminate. The non-woven thermoplastic fabric can be subjected to special calendaring processes, spot-welding, etc. to improve its physical properties. The open mesh fabric, non-woven thermoplastic fabric and the organic Kraft and felt paper 15 can be treated by methods well known in the art to improve the exposed surface stability thereof. The non-woven thermoplastic fabric, organic Kraft paper and organic felt paper 15 preferably have a weight of at least one ounce per square yard. The polymeric foam layer can be naturally permeable to the flow of air and moisture vapor therethrough or the desired permeability can be obtained by perforating, special calendaring or otherwise mechanically working the foam layer 15. The polymeric foam layer 15 can be formed from polystyrene, polyurethane or a urethane derivative and has a density of from about 0.5 to 3 pounds per cubic foot.

In a preferred embodiment of the present invention, the monolithic liquid barrier and vapor permeable coating 12, open mesh thermoplastic fabric 11, and substrate 15 are extrusion coated such that the monolithic liquid barrier and vapor permeable coating 12 melts, fills the spaces 6 between the vertical strand 13 and the horizontal strand 14 of the thermoplastic fabric and adheres directly to the substrate 15.

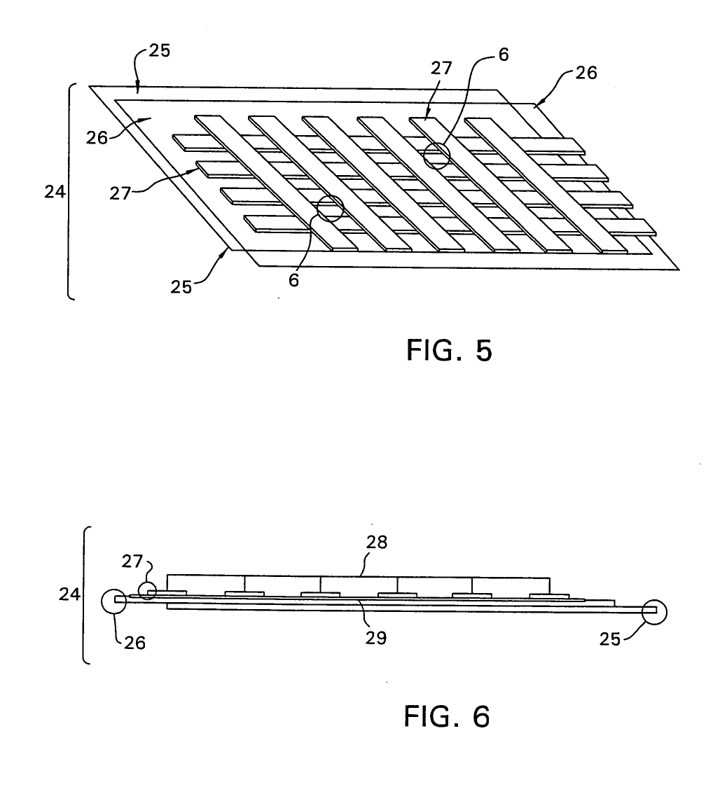

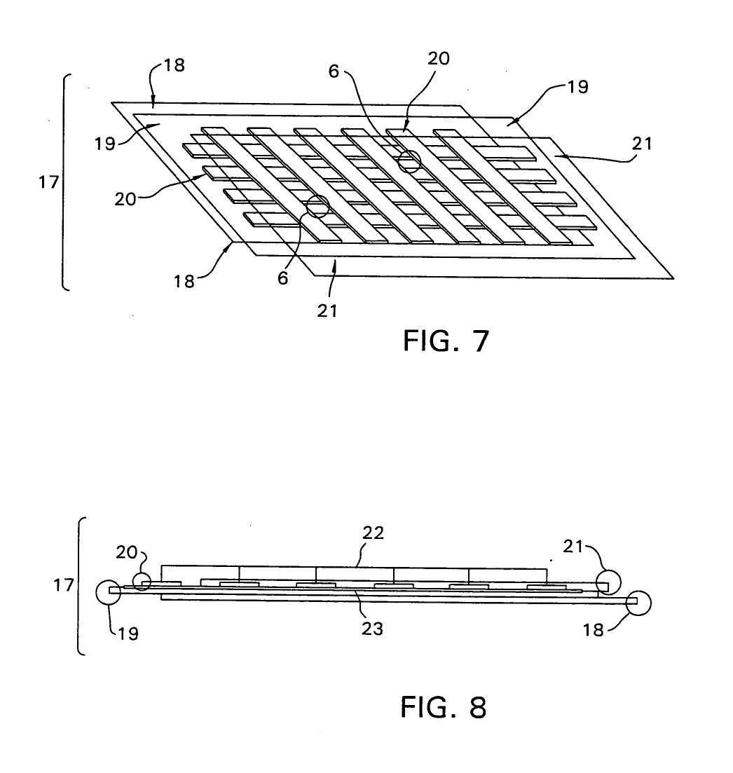

Alternatively, as shown in FIGS. 5 and 6, a laminate 24 according to the present invention can be formed by placing the monolithic liquid barrier and vapor permeable coating between the open mesh fabric 27 having vertical strands 28, horizontal strands 29 and spaces 6 and the substrate 25 of non-woven thermoplastic fabric, polymeric foam layer, organic Kraft paper or organic felt paper. The coating 26 can service as an adhesive to bond layers 25 and 27 together. The laminate 24 can be formed by applying the coating or film 26 onto either the fabric 27 or the substrate 25 and then laminating the other layer onto the coating or film 26. Alternatively, all three layers 25, 26, 27 can be co-extruded together with the coating 26 provided between thermoplastic layers 25 and 27. Additionally, as shown in FIGS. 7 and 8, the laminate 17 can have the monolithic liquid barrier and vapor permeable coating or film 19, 21 provided on both sides of the open mesh fabric 20 and between the substrate 18 and fabric 20. As in the previous embodiments, fabric 20 comprises horizontal strands 23, vertical strands 22 and spaces 6.

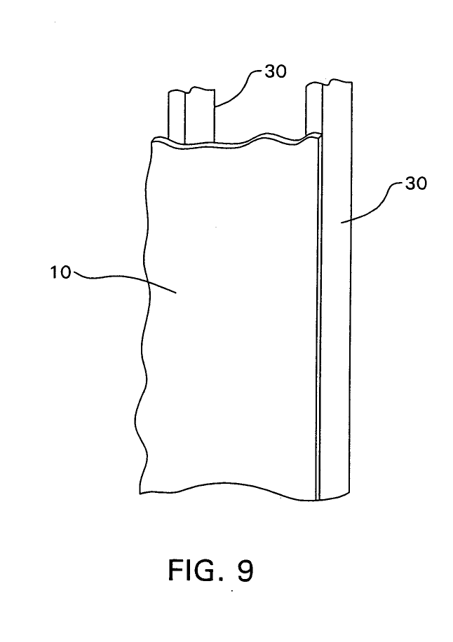

As shown in FIG. 9, the laminate 10 of the present invention can be attached to at least one framing member 30 in a building structure such as an exterior wall or roof and substantially prevents the passage therethrough of air and water but allows the transmission of moisture vapor at a rate of at least one perm. The laminate of the present invention can also be attached to exterior sheathing such as plywood. Due to its simple construction, it is much more economical than the materials currently on the market and yet possesses a high strength and durability.

The laminates of the present invention can also be used in roofing systems as an underlayment, as an undersiding for a recreational vehicle and as a window flashing adhered around window flanges and jambs. In all of these utilities, the inventive laminates function to prevent the intrusion of air and bulk moisture yet allow the outward passage of moisture vapor.

1. A laminate having a moisture vapor transmission rate greater than 1 perm, said laminate comprising an open mesh fabric having a monolithic liquid barrier and vapor permeable coating provided on a surface thereof.

2. The laminate of claim 1, wherein an open mesh glass, graphite, acrylic or polycarbonate fabric is used.

3. The laminate of claim 1, wherein an open mesh thermoplastic fabric is used.

4. The laminate of claim 3, wherein the open mesh thermoplastic fabric is thermally bonded.

5. The laminate of claim 1, additionally comprising a substrate selected from the group consisting of a non-woven thermoplastic fabric, polymeric foam layer, organic Kraft paper and organic felt paper provided on an opposite surface of the open mesh fabric.

6. The laminate of claim 5, wherein a non-woven thermoplastic fabric is provided on the opposite surface of the open mesh fabric.

7. The laminate of claim 5, wherein an organic felt paper is provided on the opposite surface of the open mesh fabric.

8. The laminate of claim 5, wherein the monolithic liquid barrier and vapor permeable coating is provided in openings formed in the open mesh fabric and bonded to the substrate.

9. The laminate of claim 1, wherein the monolithic liquid barrier and vapor permeable coating is provided between the open mesh fabric and a substrate selected from the group consisting of a non-woven thermoplastic fabric, polymeric foam layer, organic Kraft paper and organic felt paper.

10. The laminate of claim 3, wherein the open mesh thermoplastic fabric is selected from the group consisting of a polyolefin, a polyester, a polyamide and mixtures thereof.

11. The laminate of claim 3, wherein the open mesh thermoplastic fabric has been treated by a corona discharge.

12. The laminate of claim 1, wherein the monolithic liquid barrier and vapor permeable coating is selected from the group consisting of a copolyester, a polyester, a polyurethane, an acrylic polymer, a polyether, an ester-ether copolymer and mixtures thereof.

13. The laminate of claim 6, wherein the non-woven thermoplastic fabric is selected from the group consisting of a polyolefin, a polyester, a polyamide and mixtures thereof.

14. A method of preventing the infiltration of air and bulk moisture to the interior of a building structure comprising the step of incorporating into the building structure a laminate comprising an open mesh fabric having a monolithic liquid barrier and vapor permeable coating provided on a surface thereof.

15. The method of claim 14, wherein the laminate additionally comprises a substrate selected from the group consisting of a non-woven thermoplastic fabric, polymeric foam layer, organic Kraft paper and organic felt paper provided on an opposite surface of the open mesh fabric.

16. The method of claim 14, wherein the laminate comprises an open mesh glass, graphite, acrylic or polycarbonate fabric.

17. The method of claim 14, wherein the laminate comprises an open mesh thermoplastic fabric.

18. The method of claim 15, wherein a non-woven thermoplastic fabric is provided on the opposite surface of an open mesh fabric.

19. The method of claim 15, wherein an organic felt paper, non-woven thermoplastic fabric, polymeric foam layer or organic Kraft paper is provided on the opposite surface of the open mesh fabric.

20. The method of claim 17, wherein the open mesh thermoplastic fabric is thermally bonded.

21. The method of claim 15, wherein the monolithic liquid barrier and vapor permeable coating is provided in openings formed in the open mesh fabric and bonded to the substrate.

22. The method of claim 14, wherein the monolithic liquid barrier and vapor permeable coating is provided between the open mesh fabric and a substrate selected from the group consisting of a non-woven thermoplastic fabric, polymeric foam layer, organic Kraft paper and organic felt paper.

23. The method of claim 17, wherein the open mesh thermoplastic fabric is selected from the group consisting of a polyolefin, a polyester, a polyamide and mixtures thereof.

24. The method of claim 17, wherein the open mesh thermoplastic fabric has been treated by a corona discharge.

25. The method of claim 14, wherein the monolithic liquid barrier and vapor permeable coating is selected from the group consisting of a copolyester, a polyester, a polyurethane, an acrylic polymer, a polyether, an ester-ether copolymer, and mixtures thereof.

26. The method of claim 18, wherein the non-woven thermoplastic fabric is selected from the group consisting of a polyolefin, a polyester, a polyamide and mixtures thereof.

27. A building structure comprising a laminate having a moisture vapor transmission rate greater than 1 perm attached to at least one framing member, said laminate comprising an open mesh fabric having a monolithic liquid barrier and vapor permeable coating provided on a surface thereof.

28. The building structure of claim 27, additionally comprising a substrate selected from the group consisting of a non-woven thermoplastic fabric, polymeric foam layer, organic Kraft paper and organic felt paper provided on an opposite surface of the open mesh fabric.

29. The building structure of claim 27, wherein the laminate comprises an open mesh glass, graphite, acrylic or polycarbonate fabric.

30. The building structure of claim 27, wherein the laminate comprises an open mesh thermoplastic fabric.

31. The building structure of claim 28, wherein a non-woven thermoplastic fabric is provided on an opposite surface of the open mesh fabric.

32. The building structure of claim 28, wherein the monolithic liquid barrier and vapor permeable coating is provided in openings formed in the open mesh fabric and bonded to the substrate.

33. The building structure of claim 27, wherein the monolithic liquid barrier and vapor permeable coating is provided between the open mesh fabric and a substrate selected from the group consisting of a non-woven thermoplastic fabric, polymeric foam layer, organic Kraft paper and organic felt paper.

34. The building structure of claim 30, wherein the open mesh thermoplastic fabric has been treated by a corona discharge.

35. A recreation vehicle undersiding for preventing bulk moisture intrusion comprising a laminate having a moisture vapor transmission rate greater than one perm, said laminate comprising an open mesh fabric having a monolithic liquid barrier and vapor permeable coating provided on a surface thereof.

36. A flexible window flashing for preventing bulk moisture intrusion and allowing moisture vapor to exit comprising a laminate having a moisture vapor transmission rate greater than one perm, said laminate comprising an open mesh fabric having a monolithic liquid barrier and vapor permeable coating provided on a surface thereof.
